(19) United States
(12) Patent Application Publication
(10) Pub. No.: US 2006/0230875 A1
(43) Pub. Date: Oct. 19, 2006

(54) Pedal assembly having a hysteresis generating structure

(76) Inventor: Jiyuan Ouyang, Windsor (CA)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/107,054

(22) Filed: Apr. 15, 2005

(51) Int. Cl. G05G 1/14

(52) U.S. Cl. 74/560

(57) ABSTRACT

A pedal assembly includes a housing (20) presenting two spaced apart inner surfaces (22) and pivotally supports a pedal arm (24). A hysteresis mechanism (30) is mounted on the pedal arm (24) and includes first and second brake elements (32, 34) to provide a resistance force to the pivotal movement of the pedal arm (24) relative to the housing (20). Each of the brake elements (32, 34) includes coacting ramps (46) along the braking axis (B) such that the brake elements (32, 34) move relative to one another along the braking axis (B) in response to the pivotal movement of the pedal arm. The coacting ramps (46) of one brake element (32, 34) is in sliding and wedging engagement with the coacting ramps (46) of the other brake element (32, 34) to move said brake elements (32, 34) relative to one another along said braking axis (B) thereby applying a resistance force equally on opposing sides of the pedal arm (24).

### BACKGROUND OF THE INVENTION

1. Field of the Invention

The subject invention relates to a vehicle foot pedal assembly having an electronic control with a hysteresis generating structure incorporated therein.

2. Description of the Prior Art

Foot pedal assemblies are used to mechanically control various vehicle functions including the engine and brakes, for example. The foot pedal assemblies usually include a pedal arm mounted to the vehicle body with a series of linkages and levers connecting the pedal arm to an associated device, i.e., carburetor, fuel injector, controller, brake drum, brake housing, clutch housing or the like. Drivers are accustomed to certain application and release pressures on a pedal arm and have become accustomed to a resistance force of the pedal arm as well as a rate of withdrawal as applied pressure is relaxed.

Typically, the pedal arm pressure required when advancing an accelerator pedal, for example, is greater than that required to maintain a fixed position. This difference is often referred to as a hysteresis effect. This effect is important in maintaining the pedal arm in position while driving at a relatively constant speed or for continuous braking. The pressure which must be applied in accelerating, for example, is easily borne but if the back pressure of an accelerator spring produced the same effect during the time it was required to retain or maintain speed, it would soon become uncomfortable for the driver to maintain a relatively constant speed. The hysteresis effect provides relief and lessens the load required to maintain a setting of the pedal arm. Yet there is still force to cause reverse pedal action when the applied pressure is removed.

An improvement in the automotive industry relating to foot pedal assemblies is the use of drive-by-wire systems. Drive-by-wire systems allow the control of the vehicle engine or brakes, for example, without the need for a direct mechanical connection between the pedal arms and the engine or brakes. A drive-by-wire system utilizes electronic or electrical means for controlling the vehicle system, i.e., the engine throttle or vehicle brakes, without the need for a direct mechanical linkage to the engine or brakes.

In the drive-by-wire systems, it is important that the pedal arm provide the customary feel and performance of a mechanical linkage. The foot pedal assemblies should function responsively to driver input and should provide non-fatiguing resistance. Drive-by-wire foot pedals therefore typically have a hysteresis mechanism that replicate the customary feel and performance of an ordinary pedal with a direct mechanical linkage. The hysteresis mechanism replicates the mechanical linkage by creating a frictional force that resists the pivotal movement of the pedal arm. The hysteresis mechanism typically utilizes a spring and braking means to create the fictional resistance. Drive-by-wire systems for vehicle engines with this type of arrangement for a hysteresis mechanism are well known in the art and one such example is U.S. Pat. No. 5,408,899.

An improved drive-by-wire system with a hysteresis mechanism is U.S. Pat. No. 6,575,053 and is assigned to the assignee of the subject invention. The '053 patent provides a pedal assembly having a hysteresis mechanism providing a pair of brake shoes biased into the housing to resist movement of the pedal arm.

### SUMMARY OF THE INVENTION

The invention provides for a pedal assembly including a housing having two inner surfaces, a pedal arm, and a hysteresis mechanism. The pedal arm is pivotally connected to the housing for movement between and parallel to the inner surfaces of the housing and the hysteresis mechanism responds to reaction forces between the pedal arm and the inner surfaces of the housing to provide a resistance to the pivotal movement of the pedal arm. The hysteresis mechanism includes a first brake element and a second brake element movable relative to one another along a braking axis extending between the inner surfaces of the housing. Each brake element presents a brake shoe that frictionally engages the inner surface of the housing. The brake elements include a pair of parallel ramps spaced from one another along the braking axis, and offset from one another laterally in a direction transverse to the braking axis. The pair of ramps of one brake element are in sliding engagement with the pair of ramps of the other brake element to move the brake elements relative to one another along the braking axis in response to the reaction forces causing the sliding movement between the ramps of the brake elements. Stated another way, the brake elements include coacting ramps in sliding engagement to move the brake elements relative to one another along the braking axis in response to the reaction forces causing sliding movement along the ramps. One of the brake elements could include a pair of fingers flanking one of the ramps for nesting and guiding the other brake element.

Accordingly, the subject invention sets forth an improved alternative design over the prior art hysteresis mechanisms.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a pedal assembly;

FIG. 2 is an exploded perspective view of the pedal assembly;

FIG. 3 is a fragmented partially cross-sectional view of the pedal assembly with one side of the housing removed to show the placement of a hysteresis mechanism;

FIG. 4 is a cross-sectional view of the pedal assembly taken along line 4-4 in FIG. 1 with a pedal arm in a rest or idle position;

FIG. 5 is a cross-sectional view of the pedal assembly taken along line 5-5 in FIG. 1 with the pedal arm in a depressed position pivotally rotated relative to the housing;

FIG. 6 is an exploded view of first and second brake elements of a hysteresis mechanism;

FIG. 7 is a front perspective view of the first brake element;

FIG. 8 is a rear perspective view of the second brake element; and

FIG. 9 is a fragmented partially cross-sectional view of an additional embodiment of the hysteresis mechanism having multiple springs.

### DETAILED DESCRIPTION OF THE PREFERRED EMBODIMENT

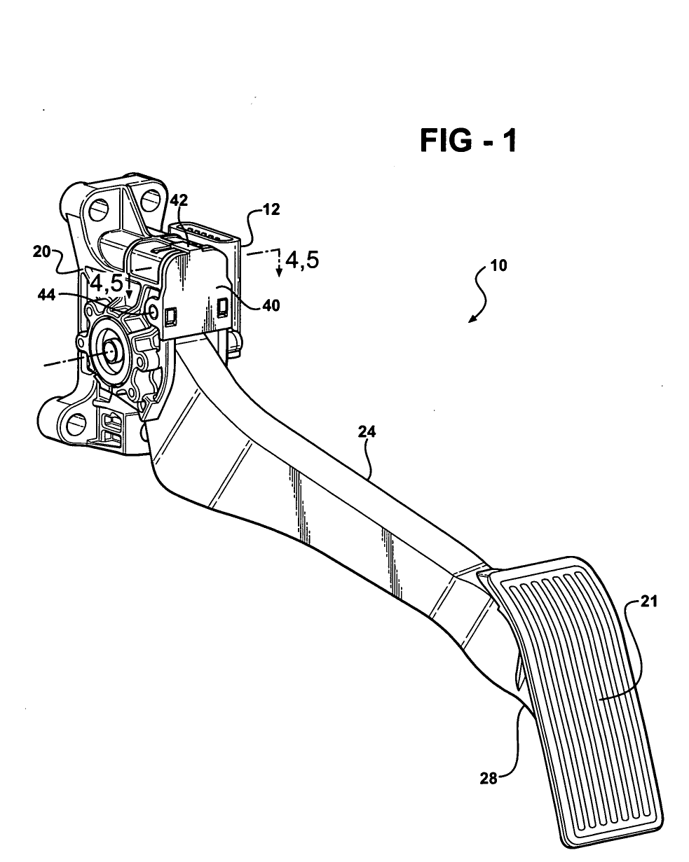

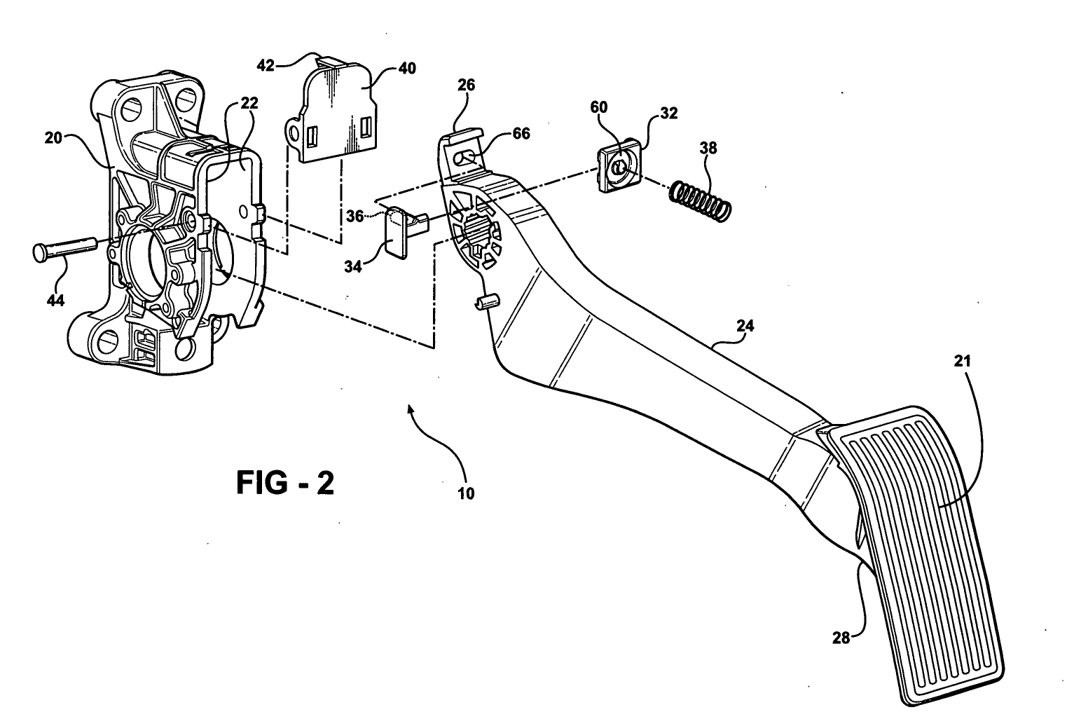

Referring to the Figures wherein like numerals indicate like or corresponding parts throughout the several views, a pedal assembly is generally shown at 10 in FIGS. 1 and 2. The pedal assembly 10 is illustrated as a drive-by-wire accelerator foot pedal having an electronic throttle control 12. It should be recognized that the subject invention described herein may be utilized on any suitable pedal assembly, and any reference to an accelerator pedal is merely for descriptive purposes and is in no way limiting.

The pedal assembly 10 includes a housing 20, presenting two spaced apart inner surfaces 22. The housing 20 pivotally supports a pedal arm 24 having a first end 26 and a second end 28. The first end 26 is disposed within the housing 20 when the pedal arm 24 is mounted to the housing 20. A pedal pad 21 is mounted to the second end 28 of the pedal arm 24. At least a portion of the pedal arm 24 pivots between and parallel to the inner surfaces 22 of the housing 20. A cover 40 is mounted to the housing 20 to substantially encapsulate the first end 26 of the pedal arm 24 within the housing 20. The cover 40 is attached to the housing 20 by a snap tab 42 and is additionally secured to the housing 20 by a fastener 44, i.e., a rivet, or by other adequate methods. A coil spring 38 reacts between the first end 26 of the pedal arm 24 and the cover 40 to continuously bias the pedal arm 24 into a rest or idle position.

The pedal assembly 10 includes a hysteresis mechanism 30 mounted on the pedal arm 24 that is responsive to reaction forces between the pedal arm 24 and the inner surfaces 22 of the housing 20. The hysteresis mechanism 30 is disposed between the first end 26 of the pedal arm 24 and the spring 38 to provide resistance to the pivotal movement of the pedal arm 24 relative to the housing 20. The hysteresis mechanism 30 simulates the variable force or hysteresis effect to duplicate the pedal performance and driver feel of an ordinary foot pedal having a direct mechanical linkage.

Referring also to FIGS. 3-5, the hysteresis mechanism 30 includes a first brake element 32 and a second brake element 34. The first brake element 32 and the second brake element 34 each present a brake shoe 36 that frictionally engages the respective inner surfaces 22 of the housing 20. The coil spring 38 engages and reacts between the first brake element 32 and the cover 40, which extends across the inner surfaces 22 of the housing 20. The coil spring 38 creates a reaction force along a reaction axis (R) in response to the pivotal movement of the pedal arm 24 relative to the inner surfaces 22 of the housing 20.

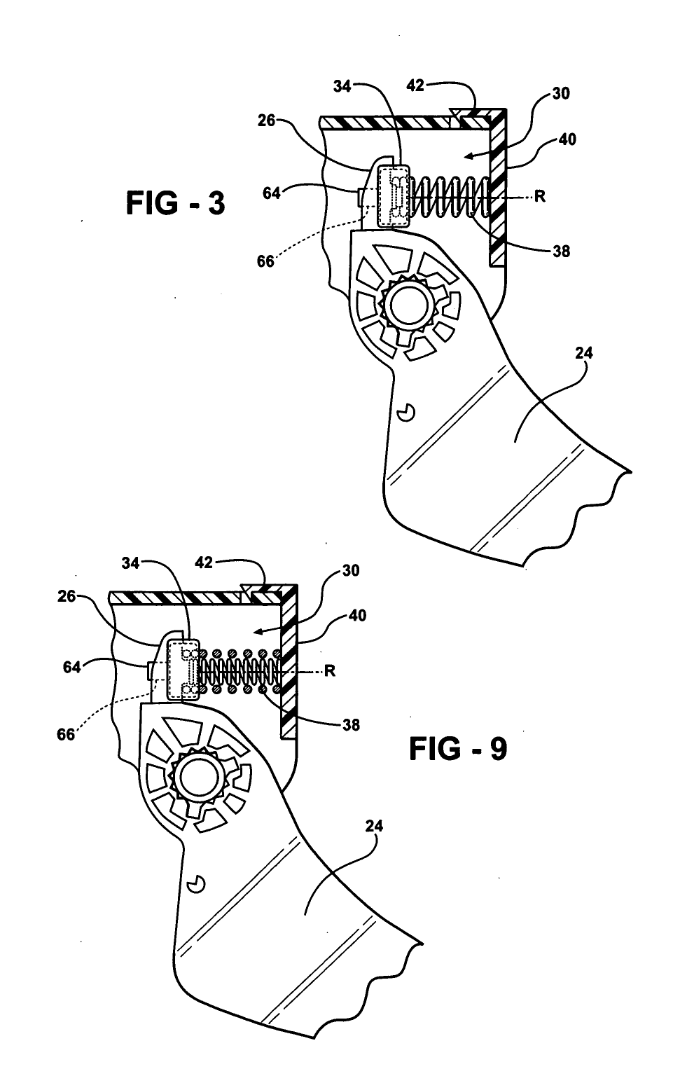

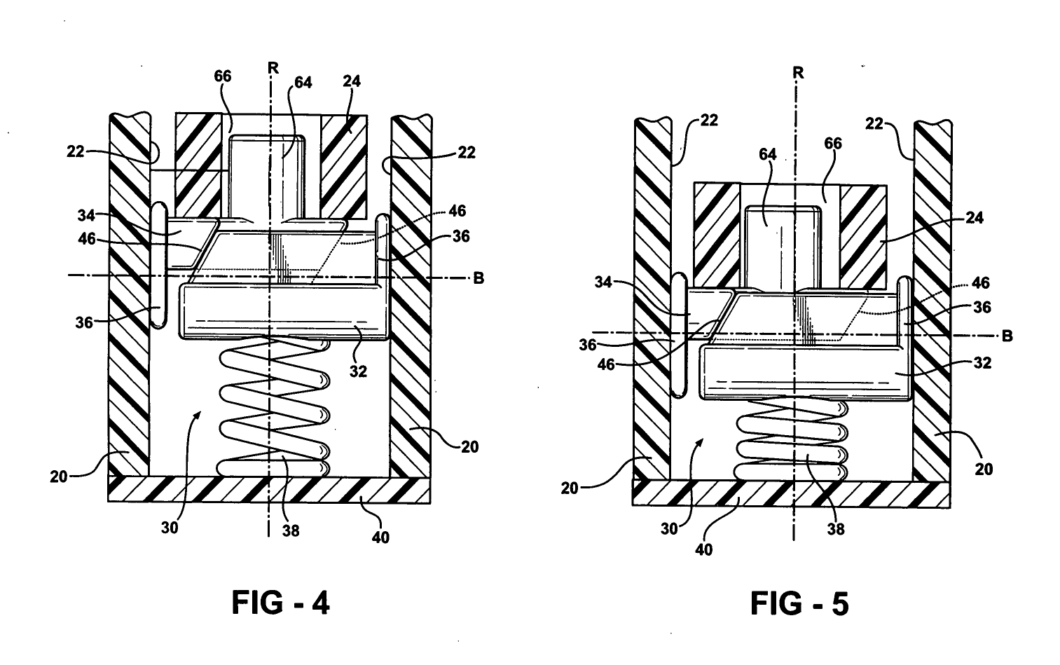

As shown in FIGS. 4 and 5, the first brake element 32 and the second brake element 34 move relative to one another along a braking axis (B) extending between the inner surfaces 22 of the housing 20, in response to the reaction force from the compression of the coil spring 38 during pivotal movement of the pedal arm 24. FIG. 4 illustrates the pedal assembly 10 in a rest position, whereas FIG. 5 illustrates the depression of the pedal arm 24 and the compression and movement of the brake elements 32, 34 as a result of the reaction force. The coil spring 38 creates the reaction force in response to movement of the pedal arm 24 as it is pivotally moved from the rest state to an operational position. It should be appreciated that the actual movement of the brake elements 32, 34 relative to each is other is relatively small and the relative movement shown in FIGS. 4 and 5 is exaggerated for illustrative purposes.

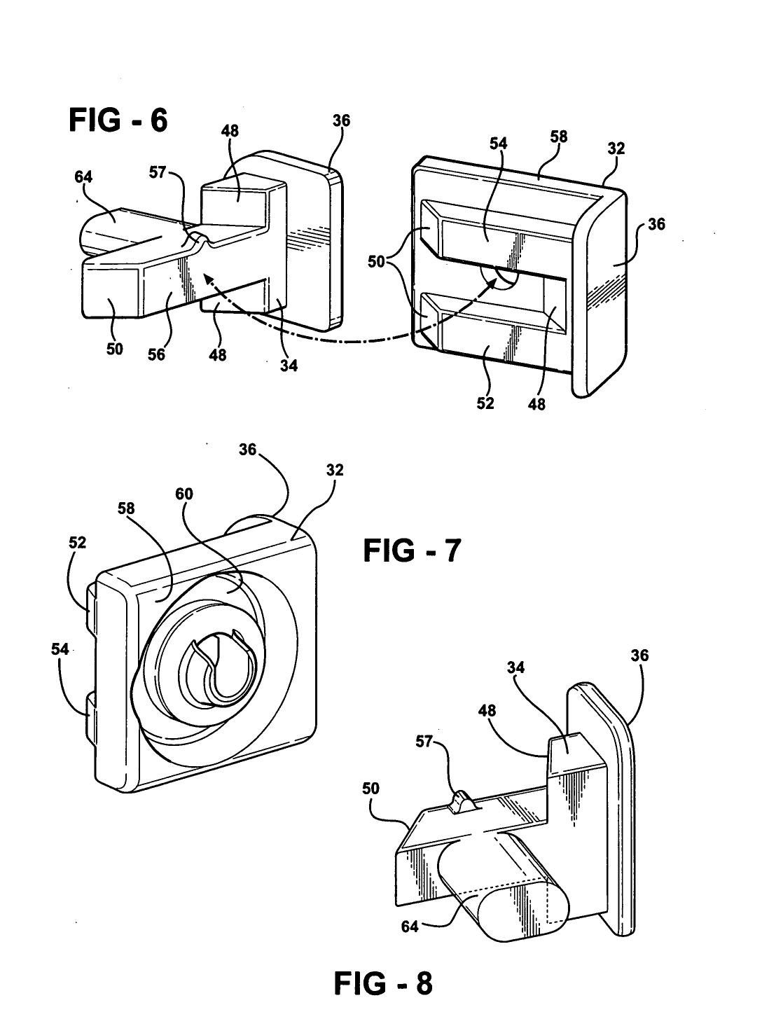

Referring also to FIGS. 6-8, each of the brake elements 32, 34 includes a pair of parallel ramps 46 spaced from one another along the braking axis (B) and the ramps 46 are offset from one another laterally in a direction transverse to the braking axis (B). The ramps 46 of one brake element 32, 34 are in a wedging and sliding engagement with the ramps 46 of the other brake element 32, 34. The wedging and sliding engagement between the respective pairs of ramps 46 moves the brake elements 32, 34 relative to one another along the braking axis (B) in response to the reaction force. Stated another way, the brake elements 32, 34 having coacting ramps 46 in sliding engagement to move the brake elements 32, 34 relative to one another along the braking axis (B). The sliding movement is a wedging action in response to the reaction forces causing the sliding between the brake elements 32, 34 along one of the ramps 46.

The pair of ramps 46 of each of the brake elements 32, 34 includes a root ramp 48 and a distal ramp 50, as shown in FIG. 6. The root ramps 48 and the distal ramps 50 of the brake elements 32, 34 are spaced along the braking axis (B) from the reaction axis (R) of the coil spring 38. The spaced ramps 46 equally distribute the reaction force of the coil spring 38 to the brake shoes 36 of the each of the brake elements 32, 34 on opposing sides of the pedal arm 24.

Each of the brake elements 32, 34 includes a finger 52, 54, 56 extending from the next adjacent root ramp 48 and parallel to the braking axis (B). The distal ramps 50 are disposed on the ends of the respective fingers 52, 54, 56 of the braking elements 32, 34. The fingers 52, 54, 56 of the brake elements 32, 34 are disposed in side-by-side relationship in a transverse direction along the braking axis (B) for sliding relative to one another as the root ramps 48 engage the distal ramps 50 of the respective brake elements 32.

One of the brake elements 32, 34 includes a pair of fingers 52, 54 flanking one of the ramps 46 for nesting and guiding the other brake element 32, 34. Specifically, the first brake element 32 includes the pair of fingers 52, 54 that are parallel with the braking axis (B) and spaced in a transverse direction from the braking axis (B). The first brake element 32 further includes one of the ramps 46 disposed between the pair of fingers 52, 54 along the braking axis (B). More specifically, the first brake element 32 includes a first finger 52 and a second finger 54 spaced and parallel to the first finger 52. The second brake element 34 includes a single finger 56 that is nestled between the pair of fingers 52, 54 of the first brake element 32. The single finger 56 of the second brake element 34 defines one of the ramps 46 that engages with one of the ramps 46 of the first brake element 32 in a sliding movement along the braking axis (B) in response to the reaction force. In addition one of the brake elements 32, 34 includes a spring seat 60.

The single finger 56 of the second brake element 34 is preferably disposed between the first finger 52 and the second finger 54 of the first brake element 32. The single finger 56 further includes a tab portion 57 that is a raised to provide a slight interference fit between the single finger 56 and the first and second fingers 52, 54 of the first brake element 32. The second brake element 34 further includes one of the root ramps 48 on each side of the single finger 56. The pair of root ramps 48 on the second brake element 34 engages the distal ramps 50 on the first finger 52 and on the second finger 54 of the first brake element 32. The first brake element 32 includes a root ramp 48 between the first finger 52 and the second finger 54 to engage with the distal ramp 50 on the single finger 56 of the second brake element 34.

The first brake element 32 further includes a flange 58 extending from the brake shoe 36 and underlying the flange 58 are the first finger 52 and the second finger 54. The flange 58 includes the spring seat 60 which engages the coil spring 38.

The hysteresis mechanism 30 further incorporates a slide guide interconnecting the second brake element 34 to the first end 26 of the pedal arm 24. The slide guide supports the second brake element 34 on the pedal arm 24 and allows the second brake element 34 to move relative to the pedal arm 24 parallel with the braking axis (B). The slide guide includes a post 64 extending from the second brake element 34, as shown in FIGS. 4-6 and 8, and an elongated oval slot 66 in the pedal arm 24, as shown in FIGS. 4 and 5. The slot 66 is elongated with sides parallel to the braking axis to guide and allow the post 64 to move parallel to the braking axis (B). The movement of the post 64 within the slot 66 along the braking axis (B) is best shown in FIGS. 4 and 5. The post 64 extending from the second brake element 34 is substantially axially aligned with the reaction axis (R) of the coil spring 38.

It should be appreciated that the hysteresis mechanism 30 can include a pair of coil springs 38, as shown in FIG. 9, to adjust the hysteresis effect and reaction force for different pedal applications.

Obviously, many modifications and variations of the present invention are possible in light of the above teachings. The invention may be practiced otherwise than as specifically described within the scope of the appended claims, wherein that which is prior art is antecedent to the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the incentive novelty exercises its utility. In addition, the reference numerals in the claims are merely for convenience and are not to be read in any way as limiting.

1. A pedal assembly for a vehicle comprising;
a housing (20) presenting two spaced apart inner surfaces (22), a pedal arm (24) having a first end (26) and a second end (28) and pivotally connected to said housing (20) for movement between and parallel to said inner surfaces (22),
a hysteresis mechanism (30) responsive to reaction forces between said pedal arm (24) and said inner surfaces (22) of said housing (20) for providing resistance to pivotal movement of said pedal arm (24) relative to said housing (20),
said mechanism including a first brake element (32) and a second brake element (34) each presenting a brake shoe (36) with said brake shoes (36) frictionally engaging said inner surfaces (22) of said housing (20) and movable relative to one another along a braking axis (B) extending between said inner surfaces (22),
characterized by each of said brake elements (32, 34) including a pair of parallel ramps (46) spaced from one another along said braking axis (B) and offset from one another laterally in a direction transverse to said braking axis (B) with said pair of ramps (46) of one brake element (32, 34) in sliding engagement with said pair of ramps (46) of the other brake element (32, 34) to move said brake elements (32, 34) relative to one another along said braking axis (B) in response to said reaction forces causing said sliding movement between said ramps (46).

2. An assembly as set forth in claim 1 wherein said pair of ramps (46) of each of said brake elements (32) includes a root ramp (48) and a distal ramp (50).

3. An assembly as set forth in claim 2 wherein each of said brake elements (32) includes a finger extending from said root ramp (48) and parallel to said braking axis (B) with said distal ramp (50) disposed on an end of said finger of said braking element (32, 34), said fingers of said brake elements (32) being disposed in side-by-side relationship in said transverse direction for sliding relative to one another along said braking axis (B) as said root ramp (48) engages said distal ramp (50) of the respective brake elements (32).

4. An assembly as set forth in claim 3 wherein said finger of said first brake element (32) is further defined as a first finger (52) and said first brake element further includes a second finger (54) spaced and parallel to said first finger (52).

5. An assembly as set forth in claim 4 wherein said finger of said second brake element is further defined as a single finger (56) being disposed between said first and second fingers (52, 54) of said first brake element (32).

6. An assembly as set forth in claim 5 wherein said second brake element (34) includes a root ramp (48) on each side of said single finger (56) with said distal ramps (50) on said first (52) and second (54) finger of said first brake element (32) engage said root ramps (48) on either side of said single finger (56) of said second brake element (34) and said distal ramp (50) on said single finger (56) of said second brake element (34) engaging said root ramp (48) between said first (52) and second (54) finger of said first brake element (32).

7. An assembly as set forth in claim 4 wherein said first brake element (32) includes a flange (58) extending from said brake shoe (36) and underlying said first finger (52) and said second finger (54).

8. An assembly as set forth in claim 7 wherein said first brake element (32) includes a spring seat (60) on said flange (58).

9. An assembly as set forth in claim 8 wherein said hysteresis mechanism (30) includes a coil spring (38) engaging said spring seat (60).

10. An assembly a set forth in claim 8 wherein said hysteresis mechanism (30) includes a pair of coil springs (38) engaging said spring seat (60).

11. An assembly as set forth in claim 9 wherein said housing (20) includes a cover (40) extending between said inner surfaces (22) with said spring (38) reacting between said cover (40) and said first brake element (32).

12. An assembly as set forth in claim 1 further including a slide guide interconnecting said pedal arm (24) and said second brake element (34) for supporting and allowing said second brake element (34) to move relative to said pedal arm (24) parallel to said braking axis (B).

13. An assembly as set forth in claim 12 wherein said slide guide includes a post (64) extending from said second brake element (34) and an elongated slot (66) in said pedal arm (24) with said post (64) slidably disposed in said slot (66).

14. An assembly as set forth in claim 13 wherein said post (64) is substantially axially aligned with said coil spring (38) on a reaction axis (R).

15. An assembly as set forth in claim 14 wherein said ramps (46) are spaced along said braking axis (B) from said reaction axis (R).

16. A pedal assembly for a vehicle comprising;
a housing (20) presenting two spaced apart inner surfaces (22), a pedal arm (24) having a first end (26) and a second end (28) and pivotally connected to said housing (20) for movement between and parallel to said inner surfaces (22), a hysteresis mechanism (30) responsive to reaction forces between said pedal arm (24) and said inner surfaces (22) of said housing (20) for providing resistance to pivotal movement of said pedal arm (24) relative to said housing (20),
said mechanism including a first brake element (32) and a second brake element (34) each presenting a brake shoe (36) with said brake shoes (36) frictionally engaging said inner surfaces (22) of said housing (20) and movable relative to one another along a braking axis (B) extending between said inner surfaces (22),
characterized by said brake elements (32, 34) including coacting ramps (46) in sliding engagement to move said brake elements (32, 34) relative to one another along said braking axis (B) in response to said reaction forces causing said sliding movement along said ramps (46) with one of said brake elements (32, 34) including a pair of fingers (52, 54) flanking one of said ramps (46) for nesting and guiding said other brake element (32, 34).

17. An assembly as set forth in claim 16 wherein said first brake element (32) further includes said pair of fingers (52, 54) parallel with said braking axis (B) and spaced in a transverse direction from said braking axis (B) with one of said ramps (46) being disposed between said pair of fingers (52, 54).

18. An assembly as set forth in claim 17 wherein said second brake element (34) includes a single finger (56) that is nestled between said pair of fingers (52, 54) of said first brake element (32).

19. An assembly as set forth in claim 18 wherein said single finger (56) of said second brake element (34) further defines one of said ramps (46) on said single finger (56) to engage with one of said ramps (46) of said first brake element (32) in a sliding movement in response to said reaction force.

20. An assembly as set forth in claim 16 wherein one of said brake elements (32, 34) includes a spring seat (60).
